(19) United States
(12) Patent Application Publication
(10) Pub. No.: US 2007/0018102 A1
(43) Pub. Date: Jan. 25, 2007

(54) Light-emitting component provided with a luminescence conversion element

(76) Inventors: Bert Braune, Wenzenbach (DE); Gunter Waitl, Regenburg (DE)

Correspondence Address: FISH & RICHARDSON PC, P.O. BOX 1022, MINNEAPOLIS, MN, 55440-1022, US

(21) Appl. No.: 10/564,071

(22) PCT Filed: Jul. 7, 2004
(86) PCT No.: PCT/DE04/01464

§ 371 Date: Jun. 19, 2006

(30) Foreign Application Priority Data
Jul. 14, 2003 (EP) 03015972.7
Dec. 30, 2003 (DE) 103 61 661.6

(51) Int. Cl. G01T 1/00

(52) U.S. Cl. 250/336.1; 977/773

(57) ABSTRACT

The invention encompasses a light-emitting component having at least one primary radiation source that in operation emits an electromagnetic primary radiation, and at least one luminescence conversion element by means of which at least a portion of the primary radiation is converted into a radiation of altered wavelength. Disposed after the luminescence conversion element in a radiation direction of the component is a filter element comprising a plurality of nanoparticles, said nanoparticles comprising a filter substance which by absorption selectively reduces the radiation intensity of at least one spectral subregion of an unwanted radiation.

This patent application claims the priority of European Patent Application 03015972.7 and German Patent Application 10361661.6, whose disclosure content is incorporated herein by reference.

The invention concerns a light-emitting component comprising at least one primary radiation source that in operation emits a primary electromagnetic radiation, and at least one luminescence conversion element by means of which at least a portion of the primary radiation is converted into a radiation of altered wavelength.

Such a component is described for example in DE 101 33 352 A1. Serving as the primary radiation source is at least one luminescent diode that emits a primary radiation in the range of 300 to 485 nm, said primary radiation being partially or completely converted into longer-wave radiation by phosphors. Components in which a primary radiation in the UV or near-UV region is converted into visible light are particularly well suited for generating white light with high color rendering by means of various phosphor materials.

A disadvantage of such components can be that they exhibit non-negligible residual emission of primary radiation in the UV or near-UV region of the spectrum. This can be the case in particular when high-power luminescent diodes are used as the primary radiation source. Such residual emission is to be avoided insofar as possible, since electromagnetic radiation in the UV or the near-visible-UV wavelength range can with intense exposure have a damaging effect on the human eye. Radiation in the UV or violet region (400-420 nm) can injure the eye, depending on the radiant power striking it. At wavelengths below 400 nm the main problem is cataract formation, i.e., clouding of the ocular lens. At wavelengths between 400 nm and 420 nm, photochemical degradation of the retina may also occur.

An object of the present invention is to specify a light-emitting component comprising means for at least partially reducing the radiation intensity of an unwanted radiation.

This object is achieved by means of a component according to Claim 1. Preferred improvements and advantageous configurations of the invention are the subject matter of the dependent claims.

According to the invention, in a component of the species recited at the beginning hereof, disposed after the luminescence conversion element in a radiation direction of the component is a filter element comprising a plurality of nanoparticles. The nanoparticles comprise a filter substance which by absorption selectively reduces the radiation intensity of at least one spectral range of an unwanted radiation.

“Nanoparticles” in connection with the invention are to be understood as particles having an average particle diameter greater than or equal to 0.1 nm and less than or equal to 100 nm.

The extent of a nanoparticle is relatively small compared to a wavelength of visible radiation. As a result, visible radiation is substantially not scattered inelastically from nanoparticles, but rather a Rayleigh scattering occurs by which the visible radiation is scattered with almost no loss of energy. Hence, the filter element reduces the radiation intensity of substantially only the wavelength range of an electromagnetic radiation generated in the component for which the filter substance is absorptive. The radiation intensity of at least a portion of the unwanted radiation can be reduced selectively in this way.

The term “unwanted radiation” does not imply in relation to the invention that this radiation is absolutely unwanted, but rather that emission of this radiation from the component is unwanted and is therefore to be avoided insofar as possible.

In an advantageous embodiment of the component, the unwanted radiation is the primary radiation or a spectral subregion of the primary radiation.

The unwanted radiation preferably is from or overlaps with a wavelength range of less than or equal to 420 nm and greater than or equal to 10 nm.

In a further embodiment of the component, the primary radiation source preferably comprises at least one luminescent diode that in operation emits UV radiation and/or blue light. The radiation intensity of the spectral subregion of the unwanted radiation is preferably reduced by least 50%.

To prevent insofar as possible any inelastic scattering of unwanted radiation from the nanoparticles, the nanoparticles advantageously have a d₅₀ value which, measured in Q₀, is smaller than or equal to 25 nm, preferably smaller than or equal to 21 nm and greater than or equal to 1 nm.

Particularly preferably, the nanoparticles have a d₅₀ value which, measured in Q₀, is smaller than or equal to 1/20 of a minimum wavelength of the unwanted radiation and greater than or equal to 1 nm. In a particularly advantageous embodiment hereof, all the nanoparticles have an average diameter that is no more than 1/20^{th} of a minimum wavelength of the unwanted radiation.

A preferred embodiment provides that the filter substance contains at least one material from the group consisting of the metal oxide group of materials, the sulfide group of materials, the nitride group of materials and the silicate group of materials. It is also possible in terms of the invention for the filter element to comprise plural subsets of nanoparticles having different filter substances. In such a case, only the filter substance of at least one of the subsets of nanoparticles need satisfy the conditions of the invention or of its embodiments.

The filter substance particularly preferably comprises at least one material from the group consisting of titanium dioxide, cerium dioxide, zirconium dioxide, zinc oxide, tungsten oxide, zinc sulfide and gallium nitride.

The nanoparticles are advantageously embedded in a matrix material that preferably is insensitive to UV radiation. To this end, the matrix material advantageously comprises at least one material from the group consisting of silicone, spin-on-glasses, silicon compounds and polymers.

To achieve the least possible sedimentation of nanoparticles in the matrix material, the nanoparticles are provided to particular advantage with a dispersion-enhancing surface coating or surface modification that improves their dispersibility in the matrix material.

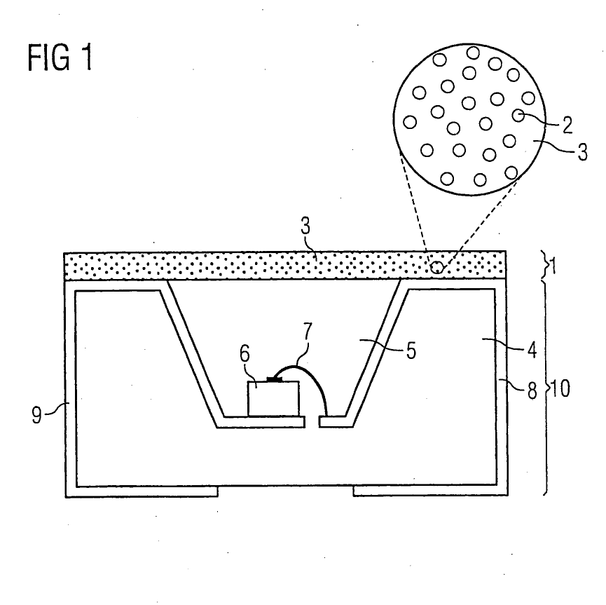

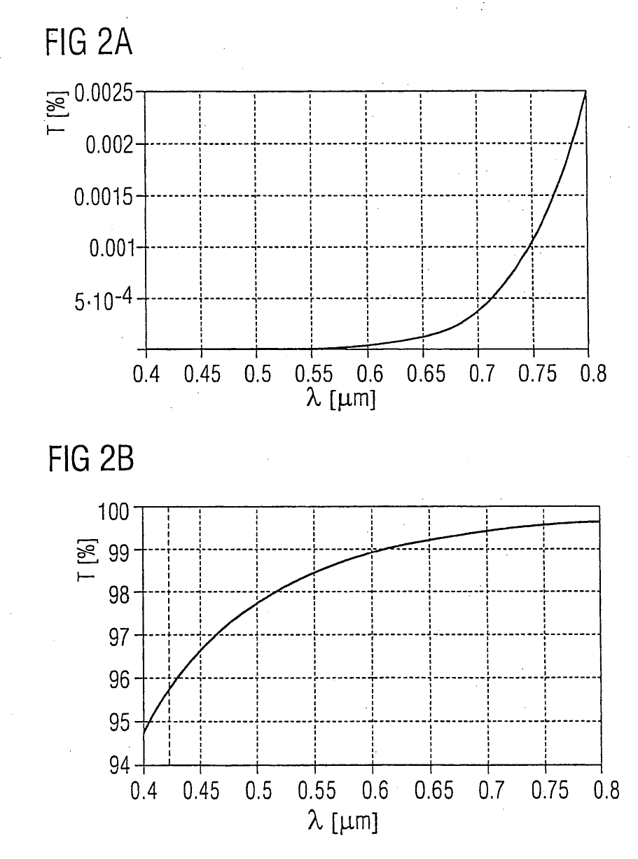

Further features, advantages and suitabilities of the invention will emerge from the exemplary embodiment described hereinafter in connection with FIGS. 1 to 2b. Therein:

FIG. 1 is a schematic sectional view of an exemplary embodiment of the component,

FIG. 2a is a calculated transmission spectrum of a filter element comprising microparticles, and

FIG. 2b is a calculated transmission spectrum of an exemplary embodiment of a filter element according to the invention.

In the exemplary embodiments and figures, like or like-acting constituents are provided with the same respective reference numerals. The illustrated elements in the figures should not be considered true to scale. Rather, they may in part be depicted as over-large to provide a better understanding.

In the exemplary embodiment shown in FIG. 1, a filter element 1 is disposed on a radiation outcoupling surface of a conventional case 10 for luminescent diodes. Case 10 has a “toplooker” design and comprises a basic case shape 4 and a first and a second electrically conductive coating 8, 9, which partially cover the walls of basic case shape 4. A luminescent diode 6 is mounted on the second electrically conductive coating 9 and thereby contacted electrically conductively therewith. The side of luminescent diode chip 6 facing away from electrically conductive coating 9 is connected electrically conductively to the second electrically conductive coating 8 by means of a bonding wire 7. The electrically conductive coating is for example reflective of an electromagnetic radiation emitted by the luminescent diode chip 6 when the latter is in operation.

Luminescent diode chip 6 comprises an epitaxially grown semiconductor layer sequence disposed on a substrate and comprising an active region (not shown) that emits electromagnetic radiation when luminescent diode chip 6 is in operation. The thickness of the semiconductor layer sequence can be 8 μm, for example.

Such a semiconductor structure can for example comprise a conventional pn junction, a double heterostructure, a single quantum well structure (SQW structure) or a multiple quantum well structure (MQW structure). Such structures are known to those skilled in the art and therefore will not be elaborated on herein. An example of a GaN-based multiple quantum well structure is described in WO 01/39282 A2, whose disclosure content in that respect is incorporated herein by reference.

The semiconductor layer sequence of luminescent diode chip 6 is based for example on InAlGaN, i.e., it contains at least one material of the composition InₓAl_{y}Ga_{1-x-x-y}N, where 0≦x≦1, 0≦y≦1 and x+y≦1. It emits an electromagnetic radiation comprising for example wavelengths in the UV range.

Luminescent diode chip 6 is encapsulated by a luminescence conversion element 5 that comprises for example a silicone-based potting compound and one or more phosphors dispersed therein. One advantage of using luminescent diode chips emitting in the UV range as the primary radiation source to excite phosphors is that light emitted by phosphors usually has a broader spectrum than light emitted by luminescent diodes. This makes it possible for example to generate white light with color rendering that is improved over that of components in which primary radiation makes up a significant portion of the emitted light.

The phosphors contained in luminescence conversion element 5 absorb a large part of the radiation emitted by the luminescent diode chip 6, which has wavelengths in the UV range, and thereupon emit radiation of greater wavelengths. The radiations emitted by different phosphors intermix and yield light of a given color space in the CIE color chart, particularly white light. Possible phosphors are, for example, phosphor particles based on YAG:Ce, YAG:Tb or other suitable inorganic or organic phosphor particles known to the skilled person as being UV-excitable.

The filter element 1 comprises a matrix material 3 mixed with nanoparticles 2. The matrix material is based for example on silicone, but can alternatively also be a glass applied by spin-coating, a silicon compound or for example a UV-stable polymer of the kind commonly used in waveguide materials.

The nanoparticles 2 comprise for example as the filter substance TiO₂, which can be present in various modifications. In the anatas modification, titanium dioxide has for example a bandgap energy of 3.2 eV, which corresponds to a wavelength of 387 nm. In a wavelength range beginning at about 400 nm to about 380 nm, the absorption coefficient of titanium dioxide in the anatas modification changes by more than two orders of magnitude.

Alternatively, the filter substance can also comprise titanium dioxide in the rutile modification, which is contained in filter element 1 for example in a concentration of approximately 15% by weight, the filter element being present in a layer 50 μm thick. The titanium dioxide is present for example in the form of particles having a d₅₀ value of 17 nm.

For such a filter element 1, FIG. 2b shows the transmission of electromagnetic radiation, considering scatter only, as a function of the wavelength of the radiation. Transmission is approximately 95% at a wavelength of about 400 nm and increases with increasing wavelength to a value of more than 99% at about 700 nm. Losses of radiation intensity due to scatter from the nanoparticles 2 of filter element 1 are therefore very slight.

FIG. 2a also shows transmission for a filter element with a 50 μm thick layer comprising about 15% by weight titanium dioxide in the rutile modification, the sole difference being that the titanium dioxide is present in the form of particles with a particle size of about 10 μm. Such a filter element is practically non-transparent to the entire visible wavelength range.

In the case of the filter element 1 yielding the transmission spectrum illustrated in FIG. 2b, if absorption in the titanium dioxide is considered in addition to scatter, sharply reduced transmission is obtained at wavelengths below about 420 nm. With radiation at a wavelength of 412 nm, transmission is only about 1%. Radiation that is damaging to the eye and therefore unwanted, such as for example primary radiation in the UV and/or shortwave blue region, can thus be reduced effectively without excessively reducing the radiation intensity of an unwanted radiation.

The scattering of the radiation emitted by the component from the nanoparticles of the filter element advantageously results in improved blending of that radiation, particularly improved blending of light of different colors.

Alternatively to a metal oxide such as for example a titanium dioxide, further suitable metal oxides, or suitable sulfides, nitrides and/or silicates, can be used alternatively or additionally as a filter substance in the exemplary embodiments. Suitable for this purpose are, for example, the materials cerium dioxide, zirconium dioxide, zinc oxide, tungsten oxide, zinc sulfide and gallium nitride, which are selected with a view toward an unwanted radiation, i.e., with regard to their absorptive properties. The quantity of nanoparticles is also adapted according to a desired reduction of the intensity of the absorbed radiation, taking the (wavelength-dependent) absorption coefficient into account.

In the context of the invention, basically all materials that are transparent to light in a visible wavelength range and absorptive of an unwanted radiation, particularly a radiation in the UV and/or violet region, are suitable for use as constituents of the filter substance.

The nanoparticles have a dispersion-enhancing surface coating or a dispersion-enhancing surface modification, i.e., they are coated with suitable molecules or such molecules are adsorbed on them such as to improve their dispersibility in the matrix material.

The protective scope of the invention is not limited to the exemplary embodiments by the description of it with reference thereto. Rather, the invention encompasses any novel feature and any combination of features, including in particular any combination of features recited in the claims, even if that combination is not explicitly mentioned in the claims or exemplary embodiments.

1. A light-emitting component comprising
at least one primary radiation source that in operation emits an electromagnetic primary radiation, and
at least one luminescence conversion element by means of which at least a portion of the primary radiation is converted into a radiation of altered wavelength, characterized in that disposed after said luminescence conversion element in a radiation direction of the component is a filter element comprising a plurality of nanoparticles, said nanoparticles comprising a filter substance which by absorption selectively reduces the radiation intensity of at least one spectral subregion of an unwanted radiation.

2. The component as in claim 1, wherein said unwanted radiation is the primary radiation or a spectral subregion of the primary radiation.

3. The component as in claim 1, wherein said unwanted radiation is from or overlaps with a UV wavelength range of less than or equal to 420 nm.

4. The component as in claim 1, wherein said primary radiation source comprises at least one luminescent diode that in operation emits UV radiation and/or blue light.

5. The component as in claim 1, wherein the radiation intensity of the spectral subregion of said unwanted radiation is reduced by at least 50%.

6. The component as in claim 1, wherein said nanoparticles have a d₅₀ value which, measured in Q₀, is less than or equal to 25 nm and greater than or equal to 1 nm.

7. The component as in claim 1, wherein said nanoparticles have a d₅₀ value which, measured in Q₀, is less than or equal to 21 nm and greater than or equal to 1 nm.

8. The component as in claim 1, wherein said nanoparticles have a d₅₀ value which, measured in Q₀, is less than or equal to one-twentieth of the minimum wavelength of an unwanted radiation and greater than or equal to 1 nm.

9. The component as in claim 1, wherein the filter substance comprises at least one material from the group consisting of the metal oxide group of materials, the sulfide group of materials, the nitride group of materials and the silicate group of materials.

10. The component as in claim 9, wherein said filter substance comprises at least one material from the group consisting of titanium dioxide, cerium dioxide, zirconium dioxide, zinc oxide, tungsten oxide, zinc sulfide and gallium nitride.

11. The component as in claim 1, wherein said nanoparticles are embedded in a matrix material.

12. The component as in claim 11, wherein said matrix material is insensitive to UV radiation.

13. The component as in claim 12, wherein said matrix material comprises at least one material from the group consisting of silicone, spin-on glasses, silicon compounds and polymers.
